(19) United States
(12) Patent Application Publication
(10) Pub. No.: US 2012/0089972 A1
(43) Pub. Date: Apr. 12, 2012

(54) Image Based Servicing Of A Virtual Machine

(75) Inventors: William L. Scheidel, Seattle, WA (US); Robert M. Fries, Kirkland, WA (US); Srivatsan Parthasarathy, Bellevue, WA (US); Alan Shi, Redmond, WA (US); James P. Finnigan, Redmond, WA (US); Rajeet Nair, Bellevue, WA (US)

(73) Assignee: Microsoft Corporation, Redmond, WA (US)

(21) Appl. No.: 12/901,004

(22) Filed: Oct. 8, 2010

(51) Int. Cl. G06F 9/44; G06F 9/445; G06F 9/455

(52) U.S. Cl. 717/168; 718/1; 717/174

(57) ABSTRACT

An invention is disclosed for preserving state in a virtual machine when patching the virtual machine (VM). In an embodiment, when a deployment manager that manages VMs in a deployment determines to patch a VM, the manager removes the VM from a load balancer for the deployment, attaches a data disk to the VM, stores application data to the data disk, swaps the prevailing OS disk for a patched OS disk, boots a gust OS stored on the patched OS disk, restores the application state from the data disk to the VM, and adds the VM back to the load balancer.

### BACKGROUND

There exist data centers that comprise a plurality of servers, each server hosting one or more virtual machines (VMs). The VMs of a data center may be managed at a central location, such as with the MICROSOFT System Center Virtual Machine Manager (SCVMM) management application. A common scenario is for a multi-tier application to be hosted in a data center, in which the logical functions of an application service are divided amongst two or more discrete processes that communicate with each other, and which may be executing on separate VMs.

An example of a multi-tier application is one that separates the aspects of presentation, logic, and data into separate tiers. In such an example, the presentation tier of the application is the point of user interaction—it displays a user interface and accepts user input. The logic tier of the application coordinates the application, processes commands, makes logical decisions and evaluations, and performs calculations. The data tier of the application stores data for the application, such as in a database or file system.

There are many problems with successfully and consistently updating or patching multi-tier applications and/or the guest OSes in which they execute in within such a data center environment. Some of these problems are well known.

### SUMMARY

It would be an advantage over prior implementations to an invention for updating or patching a guest OS in a data center.

A problem with prior techniques for patching guest OSes stems from the act of patching guest OSes itself. A typical scenario for patching a guest OS involves executing computer-executable instructions within the guest OS of the VM. Patching a guest OS this way may be highly dependent on the current state of the VM and guest OS, and very error prone. For instance, VMs and guest OSes may “drift”—change their state over time so as to be different from their initial state. This may occur, for instance, where a user logged into the guest OS moves a file that is required to effectuate the patch. When the instructions effectuating the patch determine that that file is not found, the patching process may fail, or behave differently on some machines than on others.

Another problem with “on-line” patching is that files needed that need to be modified may be locked or otherwise un-modifiable, which prevents successful patching. In sum, it is difficult and risky to perform on-line patching, because the state of the machine may vary.

A data center management program allows administrators to model multi-tier applications to allow for automated deployment and servicing of those applications. Once a service template is defined, the Administrator may deploy a new instance of the service from the service template. After the service has been deployed, the data center management program maintains a link to the service template from which it was deployed.

When a service template is later updated, such as to include a new version of an application, the Administrator can decide which services to move to the new version of the service template. When a service is moved to a new version of a service template, VMM determines the changes that have been made and the list of actions that must be applied to each tier in the service to make the service instance match the service template. Prior VMM implementations never maintained this linkage, which resulted in a “fire and forget” scenario, where changes between a service template and service instances could never be detected, let alone remedied.

In the case of application and OS updates, VMM includes the ability to apply the updates using an image-based servicing technique in which new versions of the OS or application are deployed instead of using the common technique of executing code (such as a .msi or .msu file) within the OS. This greatly improves overall reliability since copying files is significantly more reliable than executing code.

During this process, the VHD that contains the guest OS image originally used to deploy the VM may be booted in on a different machine (such as a lab environment) and any patches may be applied to it there. This VHD with the newly-patched OS may then be given back to VMM so that a service template may be created that refers to this VHD. This increases the reliability of the patching process, because then an administrator may confirm that the patch(es) were applied successfully on the image.

VMM then captures any pre-existing application state from the VM that is being updated. For certain types of applications, such as some applications that run on an application virtualization platform (like MICROSOFT APPLICATION VIRTUALIZATION or APP-V), the application state is captured as a part of application execution. For applications where state is not captured as a part of execution, VMM provides an extensible mechanism that allows Administrators to identify where application state is being stored that will need to be recovered (such as particular registry keys or file system locations). To persist this state, VMM attaches a new data disk to the VM to which the application state is then persisted.

Once the application state has been persisted, the original VHD that the VM was booting from is deleted and the updated VHD is deployed to the same location. Optionally, the original VHD may be kept, such as in a scenario where an applied patch may be rolled back, and the guest OS from the original VHD is used again. The VM is then booted and the new VHD is customized and applications are redeployed based on the updated service template model. Some information regarding customizing the VHD and redeploying applications may be found within a service template; other information may be generated based on a pattern or technique set forth by the template (for example, the service template may specify the machine name should have the form “WEB-##” where # represents an integer; VMM may then generate machine names such as WEB-01 and WEB-02 as it recreates machines that have this pattern in their service template). This invention for persisting state has the added benefit of returning the machine to a known good state by effectively undoing any changes that have been made to the machine that are not captured in the application model (e.g. a setting change that was made via a remote desktop connection to the machine).

Once the virtual machine is running, the application state can then be reapplied. Again, for state separated-applications, such as applications that run on an application virtualization platform, this process is done by VMM as a part of servicing the application. For other types of applications, VMM provides an extensible mechanism that allows administrators to apply any state that was previously captured, as needed. After application state has been re-applied, the data disk may be detached from the VM so that the VM is in a state described by a service template.

It can be appreciated by one of skill in the art that one or more various aspects of the invention may include but are not limited to circuitry and/or programming for effecting the herein-referenced aspects of the present invention; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

The systems, methods, and computer-readable media for image-based servicing of a virtual machine are further described with reference to the accompanying drawings in which:

FIG. 1 depicts an example general purpose computing environment in which in which aspects of an embodiment of the invention may be embodied.

FIG. 2 depicts an example virtual machine host wherein aspects of an embodiment of the invention can be implemented.

FIG. 3 depicts a second example virtual machine host wherein aspects of an embodiment of the invention can be implemented.

FIG. 4 depicts example operational procedures where a virtual machine is serviced, but state is not stored.

FIG. 5 depicts example operational procedures where a virtual machine is serviced, and state is stored.

FIG. 6 depicts an example virtual machine deployment where a virtual machine is serviced, and state is stored.

### DETAILED DESCRIPTION OF ILLUSTRATIVE EMBODIMENTS

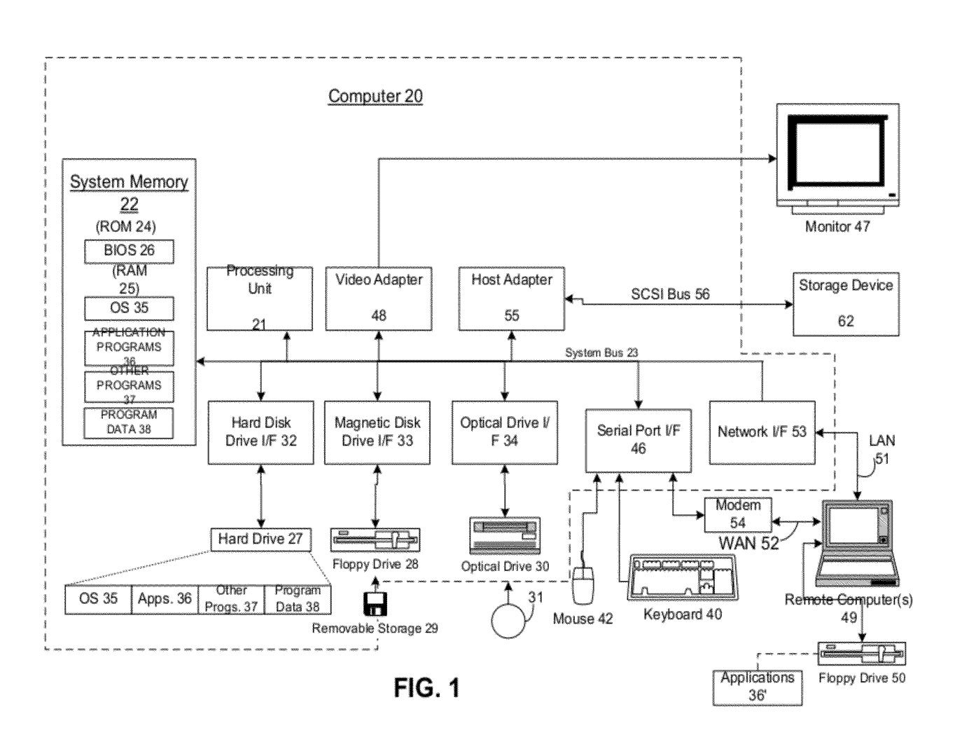

Embodiments may execute on one or more computer systems. FIG. 1 and the following discussion are intended to provide a brief general description of a suitable computing environment in which the disclosed subject matter may be implemented.

The term processor used throughout the description can include hardware components such as hardware interrupt controllers, network adaptors, graphics processors, hardware based video/audio codecs, and the firmware used to operate such hardware. The term processor can also include microprocessors, application specific integrated circuits, and/or one or more logical processors, e.g., one or more cores of a multi-core general processing unit configured by instructions read from firmware and/or software. Logical processor(s) can be configured by instructions embodying logic operable to perform function(s) that are loaded from memory, e.g., RAM, ROM, firmware, and/or mass storage.

Referring now to FIG. 1, an exemplary general purpose computing system is depicted. The general purpose computing system can include a conventional computer 20 or the like, including at least one processor or processing unit 21, a system memory 22, and a system bus 23 that communicative couples various system components including the system memory to the processing unit 21 when the system is in an operational state. The system bus 23 may be any of several types of bus structures including a memory bus or memory controller, a peripheral bus, and a local bus using any of a variety of bus architectures. The system memory can include read only memory (ROM) 24 and random access memory (RAM) 25. A basic input/output system 26 (BIOS), containing the basic routines that help to transfer information between elements within the computer 20, such as during start up, is stored in ROM 24. The computer 20 may further include a hard disk drive 27 for reading from and writing to a hard disk (not shown), a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are shown as connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the computer 20. Although the exemplary environment described herein employs a hard disk, a removable magnetic disk 29 and a removable optical disk 31, it should be appreciated by those skilled in the art that other types of computer readable media which can store data that is accessible by a computer, such as flash memory cards, digital video disks, random access memories (RAMs), read only memories (ROMs) and the like may also be used in the exemplary operating environment. Generally, such computer readable storage media can be used in some embodiments to store processor executable instructions embodying aspects of the present disclosure.

A number of program modules comprising computer-readable instructions may be stored on computer-readable media such as the hard disk, magnetic disk 29, optical disk 31, ROM 24 or RAM 25, including an operating system 35, one or more application programs 36, other program modules 37 and program data 38. Upon execution by the processing unit, the computer-readable instructions cause the actions described in more detail below to be carried out or cause the various program modules to be instantiated. A user may enter commands and information into the computer 20 through input devices such as a keyboard 40 and pointing device 42. Other input devices (not shown) may include a microphone, joystick, game pad, satellite dish, scanner or the like. These and other input devices are often connected to the processing unit 21 through a serial port interface 46 that is coupled to the system bus, but may be connected by other interfaces, such as a parallel port, game port or universal serial bus (USB). A monitor 47, display or other type of display device can also be connected to the system bus 23 via an interface, such as a video adapter 48. In addition to the display 47, computers typically include other peripheral output devices (not shown), such as speakers and printers. The exemplary system of FIG. 1 also includes a host adapter 55, Small Computer System Interface (SCSI) bus 56, and an external storage device 62 connected to the SCSI bus 56.

The computer 20 may operate in a networked environment using logical connections to one or more remote computers, such as a remote computer 49. The remote computer 49 may be another computer, a server, a router, a network PC, a peer device or other common network node, and typically can include many or all of the elements described above relative to the computer 20, although only a memory storage device 50 has been illustrated in FIG. 1. The logical connections depicted in FIG. 1 can include a local area network (LAN) 51 and a wide area network (WAN) 52. Such networking environments are commonplace in offices, enterprise wide computer networks, intranets and the Internet.

When used in a LAN networking environment, the computer 20 can be connected to the LAN 51 through a network interface or adapter 53. When used in a WAN networking environment, the computer 20 can typically include a modem 54 or other means for establishing communications over the wide area network 52, such as the Internet. The modem 54, which may be internal or external, can be connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

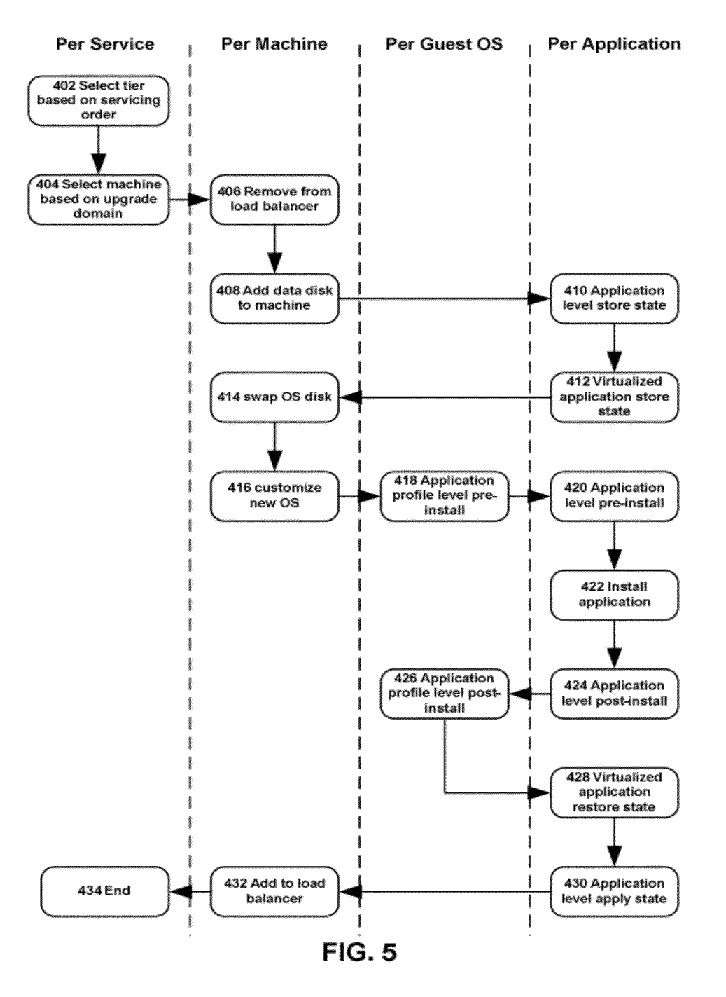

System memory 22 of computer 20 may comprise instructions that, upon execution by computer 20, cause the computer 20 to implement the invention, such as the operational procedures of FIG. 5.

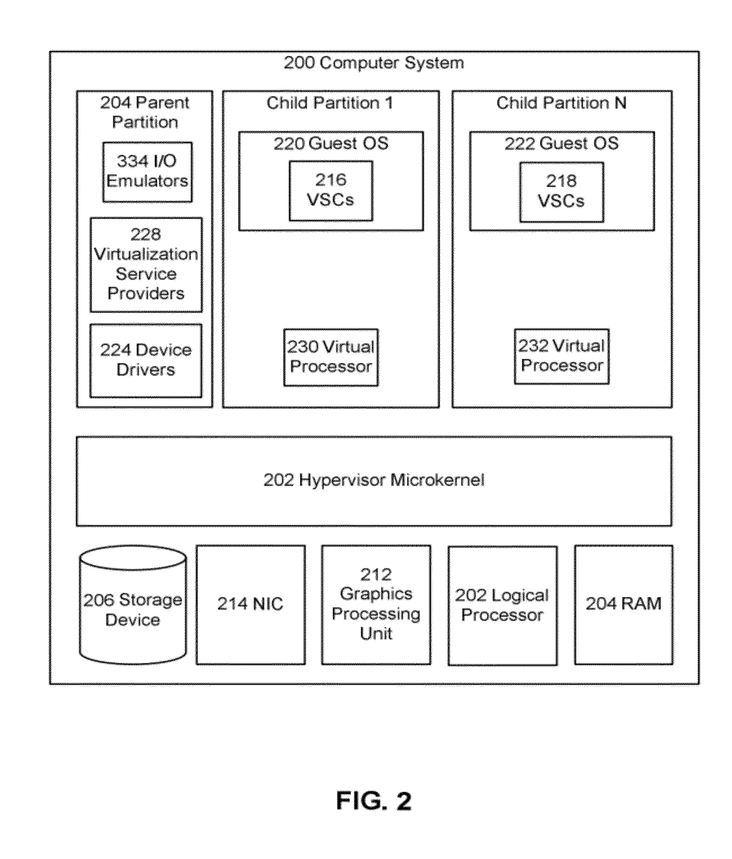

FIG. 2 depicts an example virtual machine host (sometimes referred to as a VMHost or host) wherein techniques described herein aspects of an embodiment of the invention wherein aspects of an embodiment of the invention can be implemented. The VMHost can be implemented on a computer such as computer 20 depicted in FIG. 1, and VMs on the VMHost may execute an operating system that effectuates a remote presentation session server. As depicted, computer system 200 comprises logical processor 202 (an abstraction of one or more physical processors or processor cores, the processing resources of which are made available to applications of computer system 200), RAM 204, storage device 206, GPU 212, and NIC 214.

Hypervisor microkernel 202 can enforce partitioning by restricting a guest operating system's view of system memory. Guest memory is a partition's view of memory that is controlled by a hypervisor. The guest physical address can be backed by system physical address (SPA), i.e., the memory of the physical computer system, managed by hypervisor. In an embodiment, the GPAs and SPAs can be arranged into memory blocks, i.e., one or more pages of memory. When a guest writes to a block using its page table, the data is actually stored in a block with a different system address according to the system wide page table used by hypervisor.

In the depicted example, parent partition component 204, which can also be also thought of as similar to “domain 0” in some hypervisor implementations, can interact with hypervisor microkernel 202 to provide a virtualization layer. Parent partition 204 in this operational environment can be configured to provide resources to guest operating systems executing in the child partitions 1-N by using virtualization service providers 228 (VSPs) that are sometimes referred to as “back-end drivers.” Broadly, VSPs 228 can be used to multiplex the interfaces to the hardware resources by way of virtualization service clients (VSCs) (sometimes referred to as “front-end drivers”) and communicate with the virtualization service clients via communication protocols. As shown by the figures, virtualization service clients can execute within the context of guest operating systems. These drivers are different than the rest of the drivers in the guest in that they may be supplied with a hypervisor, not with a guest.

Emulators 234 (e.g., virtualized integrated drive electronics device (IDE devices), virtualized video adaptors, virtualized NICs, etc.) can be configured to run within the parent partition 204 and are attached to resources available to guest operating systems 220 and 222. For example, when a guest OS touches a register of a virtual device or memory mapped to the virtual device 202, microkernel hypervisor can intercept the request and pass the values the guest attempted to write to an associated emulator.

Each child partition can include one or more virtual processors (230 and 232) that guest operating systems (220 and 222) can manage and schedule threads to execute thereon. Generally, the virtual processors are executable instructions and associated state information that provide a representation of a physical processor with a specific architecture. For example, one virtual machine may have a virtual processor having characteristics of an INTEL x86 processor, whereas another virtual processor may have the characteristics of a PowerPC processor. The virtual processors in this example can be mapped to logical processors of the computer system such that the instructions that effectuate the virtual processors will be backed by logical processors. Thus, in an embodiment including multiple logical processors, virtual processors can be simultaneously executed by logical processors while, for example, other logical processors execute hypervisor instructions. The combination of virtual processors and memory in a partition can be considered a virtual machine.

Guest operating systems can include any operating system such as, for example, a MICROSOFT WINDOWS operating system. The guest operating systems can include user/kernel modes of operation and can have kernels that can include schedulers, memory managers, etc. Generally speaking, kernel mode can include an execution mode in a logical processor that grants access to at least privileged processor instructions. Each guest operating system can have associated file systems that can have applications stored thereon such as terminal servers, e-commerce servers, email servers, etc., and the guest operating systems themselves. The guest operating systems can schedule threads to execute on the virtual processors and instances of such applications can be effectuated.

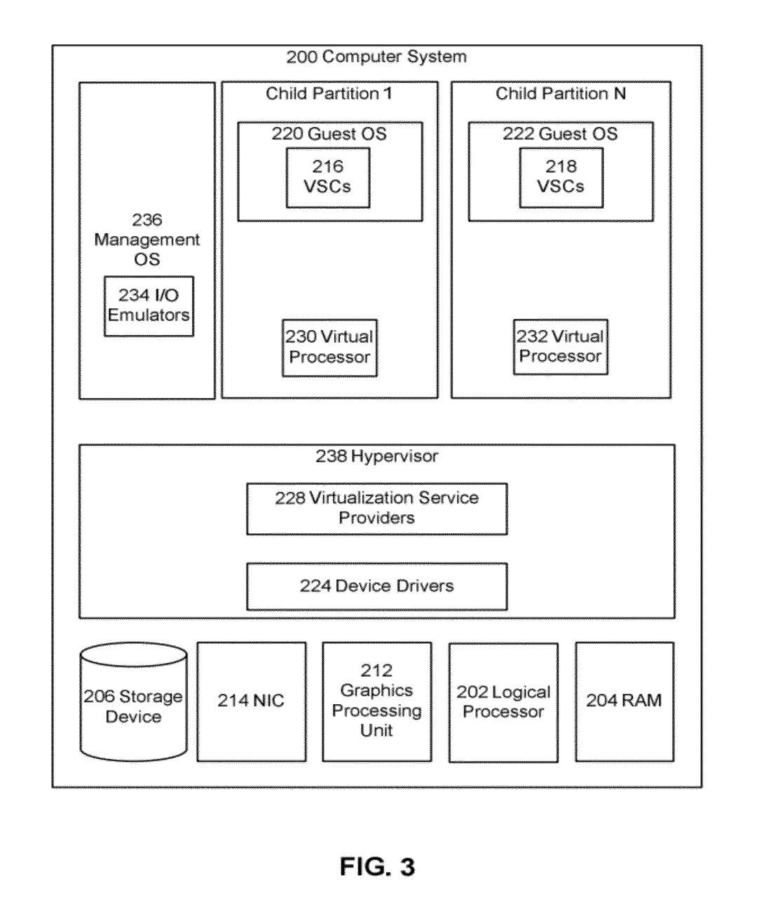

FIG. 3 depicts a second example VMHost wherein aspects of an embodiment of the invention can be implemented. FIG. 3 depicts similar components to those of FIG. 2; however in this example embodiment the hypervisor 238 can include the microkernel component and components from the parent partition 204 of FIG. 2 such as the virtualization service providers 228 and device drivers 224 while management operating system 236 may contain, for example, configuration utilities used to configure hypervisor 204. In this architecture hypervisor 238 can perform the same or similar functions as hypervisor microkernel 202 of FIG. 2; however, in this architecture hypervisor 234 can be configured to provide resources to guest operating systems executing in the child partitions. Hypervisor 238 of FIG. 3 can be a stand alone software product, a part of an operating system, embedded within firmware of the motherboard or a portion of hypervisor 238 can be effectuated by specialized integrated circuits.

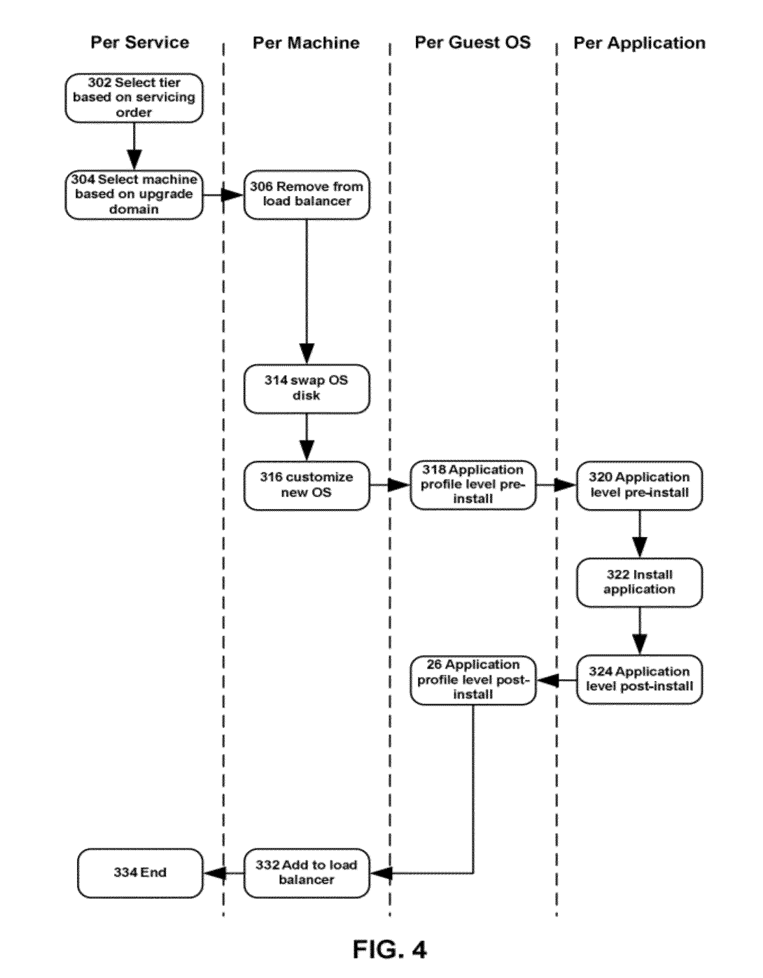

FIG. 4 depicts example operational procedures where a virtual machine is serviced, but state is not stored. The virtual machine described with respect to the operational procedures of FIG. 4 may be a virtual machine that executes upon a VMHost of FIG. 2 or 3.

The operational procedures of FIG. 4 begin with operation 302. Operation 302 depicts selecting a tier to patch based on a servicing order. Where the service to be patched comprises a multi-tier service, it may be that not all tiers of the service are to be patched, but that a single tier is to be patched. This single tier may be determined from a servicing order that identifies the nature of the patching for the service that is to occur, and the machine or machines of this identified tier may also be identified. Where there are multiple tiers to be patched for the service, the operational procedures of FIG. 4 may be implemented for each such tier.

Operation 304 depicts selecting a machine to patch based on an upgrade domain. The domain of machines to be patched and/or upgraded may be each machine of the tier identified in operation 02.

Operation 306 depicts removing the machine to patch from a load balancer. It may be appreciated that, in scenarios where there is no load balancer, the invention may be implemented without operation 306 (or operation 332, which depicts adding the machine back to the load balancer). A load balancer receives requests to use resources of the data center and determines a machine in the data center that will service that request. For instance, clients may contact the data center to access the web tier of a multi-tier application. That contact is received by the load balancer, which determines an appropriate machine to serve the web tier to the client of those machines configured to serve the web tier. This determination may be made, for instance, based on the machine with the highest available load, or in a round-robin fashion.

To determine a machine to process a request, a load balancer may maintain a list of available machines in the data center. By removing the machine to patch from the load balancer's options, the machine may be taken offline and patched without the load balancer attempting to direct requests to the machine while it is unavailable to service those requests.

Operation 314 depicts recreating the VM. A VM have an OS disk attached to it, and then may mount the disk—such as a VHD—and boot a guest OS that is stored on the disk. As depicted in FIG. 4, the VM may be serviced, such as by installing a new guest OS on it (that may be a patched version of an existing guest OS)—and this involves swapping the OS disk. To swap an OS disk, the current OS disk may be detached from the VM, and the new OS disk attached, such that the VM mounts the new OS disk, and boots a guest OS from it.

The VM may also be recreated with the same OS as before, and this may or may not involve swapping the OS disk. The act of recreating a VM may comprise both shutting down or otherwise terminating the VM, then creating or restarting it anew.

Operation 316 depicts customizing the new OS. The OS may be installed from a gold image, which comprises a genericized version of the OS—one without any machine-specific information, such as a machine name, or a security identifier (SID). That machine specific information may be unique to the INTERNET as a whole, or among an intranet or workgroup. Customizing the new OS, then, may comprise adding this machine-specific information to a generic OS. While operation 316 refers to customizing a “new” OS, it may be appreciated that there are scenarios where the VM is merely recreated with the same OS (and same VHD) as it had before. Such a scenario may occur where there is no patch to apply to the OS, but it is being recreated to avoid any possible problems due to skew.

Operation 318 depicts application profile-level pre-install. Beyond customizing the new OS, operations may be implemented that prepare all applications of the OS to be installed. These application profile-level pre-installation procedures may include configuring firewall rules, OS settings, or other machine-level configuration procedures.

Operation 320 depicts application level pre-install. Just as pre-installation procedures may be implemented across an entire profile or machine (as depicted in operation 318), pre-installation procedures may also be implemented for a single application (the application installed in operation 322). This may comprise similar operations as in operation 318, but in the per-application context, such as opening a specific port in a firewall that a specific application uses.

Operation 322 depicts installing the application. This may comprise copying files for the application to one or more places in a file system of the new guest OS. This may also comprise executing an installer for the application, such as a MICROSOFT Windows Installer installer program for versions of the MICROSOFT WINDOWS operating system.

Operation 324 depicts application-level post-install. Operation 324 may be similar to operation 320—application-level pre-install. There may be some operations done before installing the application, because installing the application is dependent on those operations having occurred. Likewise, there may be some operations that are dependent on the application having been installed, such as backing up log files that were created in the process of installing the operation.

Operation 326 depicts application profile-level post-install. Operation 326 may be similar to operation 318. Just like with operations 320 and 324 (depicting pre-install and post-install at the application level), there may be some post-install operations performed at the profile level, and these may occur in operation 326.

Operation 332 depicts adding the machine to the load balancer. This operation may be the analog of operation 406, where the machine was removed from the load balancer. Here, the machine is added to the load balancer, so that the load balancer is configured to be able to assign incoming load to the machine based on a load balancing policy or technique.

Operation 334 depicts that the operational procedures have ended. When the operational procedures reach operation 334, the machine has been serviced.

FIG. 5 depicts example operational procedures where a virtual machine is serviced, and state is stored. The virtual machine described with respect to the operational procedures of FIG. 4 may be a virtual machine that executes upon a VMHost of FIG. 2 or 3. The operational procedures of FIG. 5 where state is stored stand in contrast to those of FIG. 4, where state is not stored.

The operational procedures of FIG. 5 begin with operation 402. Operation 402 depicts selecting a tier to patch based on a servicing order. Operation 402 may be performed in a manner similar to operation 306 of FIG. 4.

Operation 404 depicts selecting a machine to patch based on an upgrade domain. Operation 404 may be performed in a manner similar to operation 306 of FIG. 4.

Operation 406 depicts removing the machine to patch from a load balancer. Operation 406 may be performed in a manner similar to operation 306 of FIG. 4.

Operation 408 depicts attaching a data disk to the machine to be patched. The data disk may be used to store application state while the VM is shut down. When the VM is recreated, but for the application state saved on this data disk, it may be that the application state will be lost because it is not found in the new VM image that is used to recreate the VM. The data disk may comprise a virtual hard drive (VHD). A VHD is typically a file that represents a hard disk, including files, folders and file structure stored thereon. The data disk may be attached to the machine to be patched, such that when the machine to be patched is booted up with the new image.

In addition to using a data disk, there are other mechanisms that may be used to store application state. For instance in a could computing platform, such as the MICROSOFT Windows Azure cloud computing platform, a Blob service may be used to store application state. A Blob service provides the ability to create a blob in which application state may be stored, store application state in the blob, and retrieve application state from the blob. These acts performed on a blob may be performed by the VM from which application state is to be stored, a hypervisor that provides virtualized hardware resources to the VM, or the deployment manager that manages the deployment.

Also in addition to using a data disk, a cloud drive may be used—storage within a cloud computing environment. Generally, these techniques for storing application state to a location outside of the VM while the VM is recreated may be referred to as storing application state to a storage location.

Operation 410 depicts storing the state of an application to the data disk. As used herein, applications may be thought to generally fall within two categories: (1) the application model, where applications are directly installed to an OS, and (2) the virtualization model, where applications are deployed on a virtual application platform, like MICROSOFT's Server App-V. Storing data from applications that adhere to the application model is handled in operation 410, while storing data from applications that adhere to the virtualization model is handled below, in operation 412. Operation 410 itself may be effectuated such as by executing scripts within the guest OS that copies files from a file system of the guest OS in which state is stored to the data disk.

It may be appreciated that, in some scenarios, all the application state to be saved is state for applications that adhere to only the application model, or in the alternative, applications that adhere to only the virtualization model. In such scenarios, it may be appreciated that the present invention may be effectuated without implementing all of the operations depicted in FIG. 5. Additionally, it may be appreciated that the order of the operations depicted in FIG. 5 is not mandatory, and that the present invention may be effectuated using permutations of the order of operations. For instance, the present invention may be effectuated in embodiments where operation 412 occurs before operation 410.

Typically, an application that adheres to the application model is installed to an operating system. As the application executes, as the application is installed, the application (or an installer for the application) may save state to places within the operating system. For instance, the application may store preference or configuration files somewhere within a file structure of the operating system, or in a configuration database, such as the WINDOWS Registry in versions of the MICROSOFT WINDOWS operating system. This application state may be monitored in a variety of ways. A process may execute on the operating system that is able to monitor the application's operations that invoke the operating system and determine which of those operations are likely to change the application's state. Operations that are likely to change state may include modifications to the Registry, or modification (including creation and deletion) of files in portions of a file system likely to indicate that that modification is one of state (such as the creation of a file in C:\Program Files in versions of the MICROSOFT WINDOWS operating system). The process may maintain a list of these modified files. When operation 410 is invoked, the process may provide that list of modified files, and those modified files may be copied to the data disk.

Another way that application state may be monitored is similar. As above, a process may execute on the operating system that is able to monitor the applications' operations that invoke the operating system. Rather than merely tracking those operations that may change application state, the process may re-direct those operations to virtualized portions of the file system or Registry, and maintain them in a separate location. For instance, when the application attempts to write to the operating system registry, the process may intercept this, and save the write to its own Registry. If the application later tries to read that which it has written to the Registry, the process may intercept this, fetch that Registry entry from its own Registry, and provide that fetched entry to the application. In such a scenario, that the data is not stored in the conventional place in the operating system is transparent. Then, when operation 410 is invoked, the process has all of the data that affects the application's state already collected, and may provide this collected information so that it is saved to the data disk.

When application state is saved from a location within a file system of the guest OS, that location within the file system may also be saved with the state, and later that location may be used when restoring the state to restore the state to the proper file system location.

Operation 412 depicts storing the state of a virtualized application. In some virtualized application scenarios, the state of virtualized applications is stored during execution in a centralized location, such as through SERVER APP-V virtualization, this may comprise storing the state stored in that centralized location to the data disk.

Operation 414 depicts swapping the OS disk. Operation 414 may be performed in a similar manner as operation 314 of FIG. 4.

Operation 416 depicts customizing the new OS. Operation 416 may be performed in a similar manner as operation 316 of FIG. 4.

Operation 418 depicts application profile level pre-install. Operation 426 may be performed in a similar manner as operation 326 of FIG. 4.

Operation 420 depicts application level pre-install. Operation 420 may be performed in a manner similar to operation 320 of FIG. 4.

Operation 422 depicts installing the application. Operation 422 may be performed in a manner similar to operation 320 of FIG. 4.

Operation 424 depicts application level post-install. Operation 424 may be performed in a manner similar to operation 320 of FIG. 4.

Operation 426 depicts application profile level post-install. Operation 426 may be performed in a similar manner as operation 326 of FIG. 4.

Operation 428 depicts restoring the state of the virtualized application. Where the state of the virtualized application was saved in operation 412 to the data disk, along with the corresponding file system location of the guest OS where the state was stored from, operation 428 may comprise copying the virtualized application state that is stored on the data disk to that file system location.

Operation 430 depicts applying the state of the saved application. Where the state of the application was saved in operation 410 to the data disk, along with the corresponding file system location of the guest OS where the state was stored from, operation 430 may comprise copying the virtualized application state that is stored on the data disk to that file system location.

Operation 432 depicts adding the machine to the load balancer. Operation 432 may be performed in a manner similar to operation 332 of FIG. 4.

Operation 434 depicts that the operational procedures have ended. Operation 434 may be performed in a manner similar to operation 334 of FIG. 4. When the operational procedures reach operation 434, the machine has been serviced. Where a service comprises multiple machines, guest OSes within one or more of those machines, or applications within one or more of those guest OSes, some of these operational procedures may be repeated to patch the entire tier. For instance, operations 306-332 may be repeated for each machine within the tier.

It may be appreciated that the order of these operations is not mandatory, and that embodiments exist where permutations of these operations are implemented. For instance, where a machine comprises only virtualized applications that have state to be saved (and not traditionally installed applications that have state to be saved), operations 410 and 430 (depicting storing the state and restoring the state, respectively, of a traditionally installed application) may be omitted. In another example where the same OS disk is used to recreate the VM, and all applications are stored in the OS disk, the invention may be implemented without implementing operations 414, 418, 420, 422, 424, or 426. Likewise, permutations exist. For instance, an embodiment of the present invention may perform operation 412 before operation 410, and/or operation 430 before operation 428.

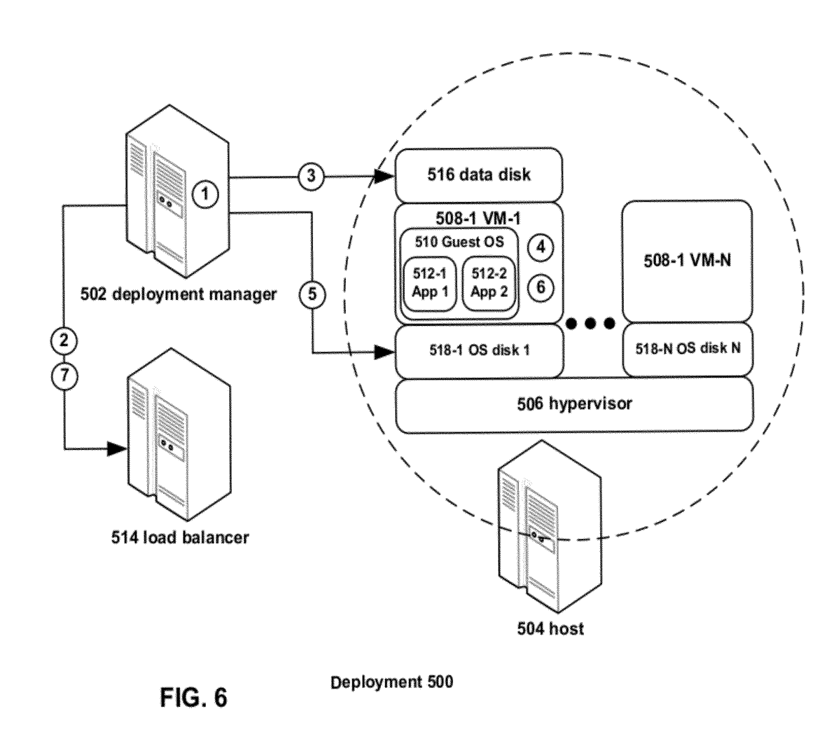

FIG. 6 depicts an example virtual machine deployment where a virtual machine is serviced, and state is stored, such as through implementing the operational procedures depicted in FIG. 5. Deployment 500 comprises deployment manager 502, host 504, and load balancer 514. In turn, host 504 comprises hypervisor 506, VMs 508-1 through N, OS disks 518-1 through N, and data disk 516. It may be appreciated that a deployment may comprise different numbers of the depicted elements, such as more than one instance of host 504, and that a host may comprise different numbers of elements, such as more or fewer than the two instances of VM 508 depicted herein.

Deployment manager 502 may comprise a service or machine that manages deployment 500—it monitors the status and health of hosts 504 within deployment 500, and may also cause the creation and termination of VMs 508 on a host 504, as well as the migration of a VM 508 from one host 504 to another host 504. Deployment manager 502 may comprise, for example, MICROSOFT System Center Virtual Machine Manager (SCVMM). Load balancer 514 maintains a list of VMs 508 of deployment 500, receives connection requests (like a request for a remote presentation session) from clients of deployment 500, and assigns an incoming connection to a VM 508. Load balancer 514 typically assigns an incoming connection to a VM 508 in a manner that balances the load among VMs 508 of deployment 500. Hypervisor 506 of host 504 manages VMs 508 on the host 504, including presenting VMs with virtual hardware resources. Each VM 508 is depicted as having a corresponding OS disk 518 that it boots a guest OS from (for instance, VM-1 508-1 is depicted as having corresponding OS disk 1 518-1). As depicted, VM-1 508-1 boots guest OS 510 from OS disk 1 518-1. Two applications execute within guest OS 510—application 1 512-1 and application 2 512-2. An application 512 may be a traditionally installed application, or a virtualized application (such as a MICROSOFT App-V virtualized application). As depicted, data disk 516 is also mounted by VM-1 508-1.

Data disk 516 and OS disks 518 need not be stored on host 504. They may be stored elsewhere and then mounted by host 504 across a communications network. For instance, OS disks 518 may be stored in a central repository for deployment 500, and then attached to a particular host 504 from that central repository.

As depicted, processes 1, 4, and 6, and communication flows 2, 3, 5, and 7 depict an order in which processes and communications may occur to effectuate the image based servicing of a VM. It may be appreciated that this series of processes and communication flows is exemplary, and other embodiments of the present invention may implement permutations and/or different combinations compared to those presented in FIG. 6. It may also be appreciated that the communication flows presented may not make up an exhaustive list of those communications that occur in a deployment 500. For instance, communication (2) depicts deployment manager sending load balancer 514 an instruction to remove a machine from its list of machines that may be assigned load. Effectuating this may involve more than just a single communication from deployment manager 502 to load balancer 514. For instance, load balancer 514 may send deployment manager 502 an acknowledgment that the instruction was carried out, or there may be additional cross-communication between deployment manager 502 and load balancer 514.

In process (1), deployment manager 502 processes a servicing order to patch a service. Deployment manager 502 selects a tier of the service to patch based on the servicing order, and selects a machine based on an upgrade domain. Process (1) may be effectuated in a similar manner as operations 402 and 404 of FIG. 5.

In communication flow (2), deployment manager 502 sends load balancer 514 an instruction to remove the machine selected in process (1) from its list of available machines that it may assign load to. Communication flow (2) may occur in a similar manner as operation 406 of FIG. 5.

In communication flow (3), deployment manager 502 adds a data disk 516 to the VM 508 selected in process (1) (herein depicted as VM-1 508-1). This communication flow (3) may occur in a manner similar to operation 408 of FIG. 5.

In process (4), VM-1 508-1 stores the state of traditionally installed applications and virtualized applications (herein depicted as application 1 512-1 and application 2 512-2) to data disk 516. This process (4) may occur in a similar manner as operations 410 and 412 as FIG. 5. As depicted, process (4) occurs within VM-1 508-1 but outside of guest OS 510. It may be appreciated that in some embodiments, process (4) occurs within guest OS 510.

Communication flow (5) depicts swapping in OS disk 1 518-1 for VM-1 508-1. Not depicted is an OS disk that has been swapped out. Communication flow (5) may occur in a similar manner as operation 414 of FIG. 5.

Process (6) depicts customizing a guest OS that was swapped in in communication flow (5); performing an application profile level pre-install for each guest OS of VM-1 508-1 (herein depicted as guest OS 510, though in embodiments, more guest OSes may be present); and for each application of each guest OS (herein depicted as application 1 512-1 and application 2 512-2), performing pre-installation functions for an application; installing the application; and performing post-installation functions for the application; performing an application profile-level post install; restoring the state of any virtualized applications; and restoring the state of any traditionally installed applications. These elements of process (6) may be performed in a similar manner as operations 418, 420, 422, 424, 426, 428, and 430 of FIG. 5, respectively.

Communication flow (7) depicts adding the patched VM 508-1 back to load balancer 514. This communication flow (7) may be performed in a similar manner as operation 432 of FIG. 5.

### CONCLUSION

While the present disclosure has been described in connection with the preferred aspects, as illustrated in the various figures, it is understood that other similar aspects may be used or modifications and additions may be made to the described aspects for performing the same function of the present disclosure without deviating there from. Therefore, the present disclosure should not be limited to any single aspect, but rather construed in breadth and scope in accordance with the appended claims. For example, the various procedures described herein may be implemented with hardware or software, or a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium. When the program code is loaded into and executed by a machine, such as a computer, the machine becomes an apparatus configured for practicing the disclosed embodiments. In addition to the specific implementations explicitly set forth herein, other aspects and implementations will be apparent to those skilled in the art from consideration of the specification disclosed herein. It is intended that the specification and illustrated implementations be considered as examples only.

What is claimed:

1. A method for preserving state when recreating a virtual machine (VM), comprising:
storing the state of an application on the VM to a storage location;
shutting down the VM;
restarting the VM;
copying the state of the application from the storage location to the VM; and
storing the state of the application in the VM.

2. The method of claim 1, further comprising:
indicating to a load balancer that the VM is not available before storing the state of the application; and
indicating to the load balancer that the VM is available after storing the state of the application in the VM.

3. The method of claim 1, wherein the application comprises a virtualized application, and wherein storing the state of the application on the VM to the storage location comprises:
storing a file stored by a virtualization program corresponding to the application to the storage location.

4. The method of claim 1, wherein the application comprises an installed application, and wherein storing the state of the application on the VM to the storage location comprises:
determining at least one file system location of the VM where the state is stored; and
storing the at least one file system location to the storage location.

5. The method of claim 1, wherein storing the state of the application on the VM to the storage location comprises:
storing a file location of the state in a file system of the VM to the storage location.

6. The method of claim 1, further comprising:
installing the application after restarting the VM.

7. The method of claim 6, further comprising:
performing an application-level pre-install before installing the application.

8. The method of claim 6, further comprising:
performing an application-level post-install after installing the application.

9. The method of claim 6, further comprising:
performing profile-level pre-install before installing the application.

10. The method of claim 6, further comprising:
performing a profile-level post-install after installing the application.

11. A system for preserving state when recreating a virtual machine (VM), comprising:
a processor; and
a memory communicatively coupled to the processor when the system is operational, the memory bearing processor-executable instructions that, upon execution by the processor, cause the processor to perform operations comprising:
storing the state of an application on the VM to a storage location;
shutting down the VM;
restarting the VM;
copying the state of the application from the storage location to the VM; and
storing the state of the application in the VM.

12. The system of claim 11, wherein restarting the VM comprises:
attaching a second disk to the VM, the second disk comprising a new guest OS; and
restarting the VM with the new guest OS.

13. The system of claim 11, further bearing processor-executable instructions that, upon execution by the processor, cause the processor to perform operations comprising:
selecting the VM based on a servicing order indicative of servicing a service that the VM executes.

14. The system of claim 11, wherein the storage location comprises a virtual hard drive (VHD).

15. The system of claim 14, further bearing processor-executable instructions that, upon execution by the processor, cause the processor to perform operations comprising:
attaching the VHD to the VM before storing the state of an application on the VM to a storage location.

16. The system of claim 11, wherein the storage location comprises:
a cloud drive of a cloud computing environment.

17. The system of claim 11, wherein the storage location comprises a blob of a blob service, and wherein storing the state of an application on the VM to a storage location comprises:
creating the blob by issuing a command to a blob service; and
writing the state of the application to the blob

18. The system of claim 11, wherein storing the state of the application on the VM to the storage location comprises:
storing a file location of the state in a file system of the VM to the storage location.

19. A computer-readable storage medium for preserving state when patching a tier of a multi-tier application to patch, virtual machine (VM) bearing computer-readable instructions, that upon execution by a computer, cause the computer to perform operations comprising:
determining a tier of a multi-tier application to patch based on a servicing order;
selecting a VM to upgrade based on an upgrade domain, the machine hosting the tier;
removing the VM from a load balancer, such that the load balancer will not assign load to the machine;
attaching a first virtual hard disk (VHD) to the VM;
storing the state of an application on the VM to the first VHD;
storing a virtualized-application state to the first VHD;
attaching a second VHD to the VM, the second VHD comprising a patched OS to be applied to the VM;
installing the application on the patched OS;
copying the state of the application from the first VHD to the patched OS; and
adding the VM to the load balancer, such that the load balancer is configured to assign load to the VM.

20. The computer-readable medium of claim 19, wherein the application is a virtualized application, and wherein storing the state of an application on the machine to the data disk comprises:
storing a file stored by a virtualization program corresponding to the application to the first VHD; and further bearing computer-readable instructions, upon execution by the computer, cause the computer to perform operations comprising:
determining to store the state of a second application, the second application being installed on the VM;
determining at least one file system location of the VM where the state of the second application is stored; and
storing the at least one file system location to the first VHD.
